(19) United States
(12) Patent Application Publication
(10) Pub. No.: US 2026/0215525 A1
(43) Pub. Date: Jul. 30, 2026

(54) PROTECTIVE GARMENT WITH EXPANDABLE SHOULDER PORTIONS

(71) Applicant: LION GROUP, INC., Dayton, OH (US)

(72) Inventors: Kathryn Ann York, Tipp City, OH (US); Calvin Clark Brant, Dayton, OH (US)

(21) Appl. No.: 19/143,046

(22) PCT Filed: Dec. 29, 2023
(86) PCT No.: PCT/US2023/086443

§ 371 Date: Jun. 25, 2025

Related U.S. Application Data
(60) Provisional application No. 63/436,197, filed on Dec. 30, 2022.

(51) Int. Cl. A41D 31/08; A41D 3/00; A41D 13/00; A62B 17/00

(52) U.S. Cl. CPC A41D 31/085; A41D 3/00; A41D 13/0005; A62B 17/003

(57) ABSTRACT

A coat including a garment portion having a body portion configured to cover a torso of a wearer, and a pair of sleeves coupled to the body portion and configured to cover a wearer's arms. The coat further includes a pleat positioned adjacent to one of the sleeves, wherein the pleat is movable between an expanded position and a retracted position. The coat also has at least one piece of elastic material coupled to the garment portion and configured to bias the pleat to the retracted position.

This application claims priority to U.S. Provisional Application Ser. No. 63/436,197, filed on Dec. 30, 2022 and entitled Protective Garment with Expandable Shoulder Portions, the entire contents of which are hereby incorporated by reference.

The present invention relates to a protective garment, and more particularly, to a protective coat with expandable shoulder portions.

### BACKGROUND

Protective or hazardous duty garments are used in a variety of industries and settings to protect the wearer from hazardous conditions such as heat, smoke, cold, sharp objects, chemicals, liquids, fumes and the like. Such protective or hazardous duty garments are often used in adverse conditions, such as in the presence of high heat or flames, or exposure to smoke or chemicals and the like. In addition, the wearers of such garments are typically placed under physical strain by carrying heavy gear and equipment, and carrying out strenuous tasks.

### SUMMARY

In one embodiment, the invention is a protective coat including an expandable shoulder portion to provide ease of movement to the wearer. More particularly, in one embodiment the invention is a coat including a garment portion having a body portion configured to cover a torso of a wearer, and a pair of sleeves coupled to the body portion and configured to cover a wearer's arms. The coat further includes a pleat positioned adjacent to one of the sleeves, wherein the pleat is movable between an expanded position and a retracted position. The coat also has at least one piece of elastic material coupled to the garment portion and configured to bias the pleat to the retracted position.

### BRIEF DESCRIPTION OF DRAWINGS

FIG. 1 is front perspective view of a coat, with portions of various layers cut away for illustrative purposes;

FIG. 2 is side-back perspective view of one embodiment of a coat, with the portions of the arm removed for illustrative purposes and with the pleat/shoulder in a retracted position;

FIG. 3 shows the coat of FIG. 2 with the pleat/shoulder in an expanded position;

FIG. 4 is a side-front perspective view of the coat of FIG. 2;

FIG. 5 is a cross section along line 5-5 of FIG. 4, showing the pleat in a retracted position;

FIG. 5A shows the pleat of FIG. 5 in an expanded position;

FIG. 6 is a back view the coat of FIG. 1 in the retracted position;

FIG. 7 is a back view of the coat of FIG. 1, with the shoulders/pleats in an expanded position;

FIG. 8 is a cross section along line 8-8 of FIG. 6;

FIG. 9 is a cross section along line 9-9 of FIG. 7;

FIG. 10 is a side-back perspective view of one embodiment of a moisture barrier of the coat of FIG. 1, with the pleat/shoulder in a retracted position;

FIG. 11 is a cross section along line 11-11 of FIG. 10;

FIG. 12 is a side-front perspective view of the liner of FIG. 10; and

FIG. 13 is a cross section along line 13-3 of FIG. 12.

### DETAILED DESCRIPTION

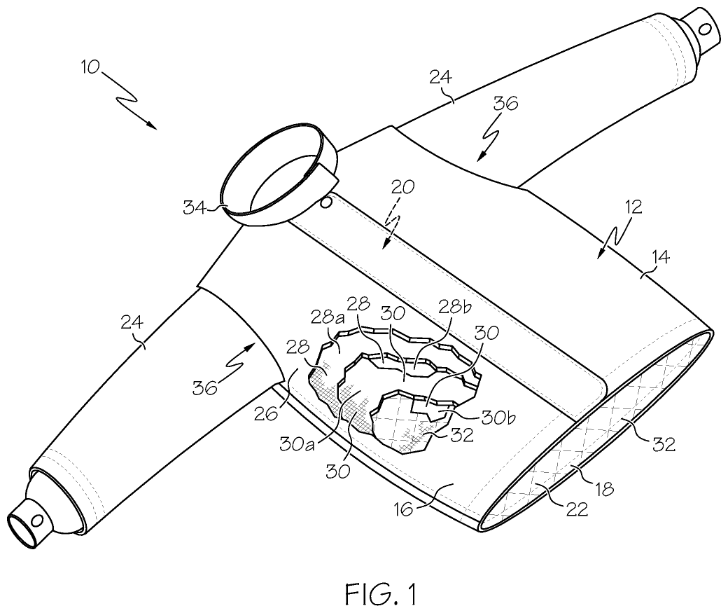

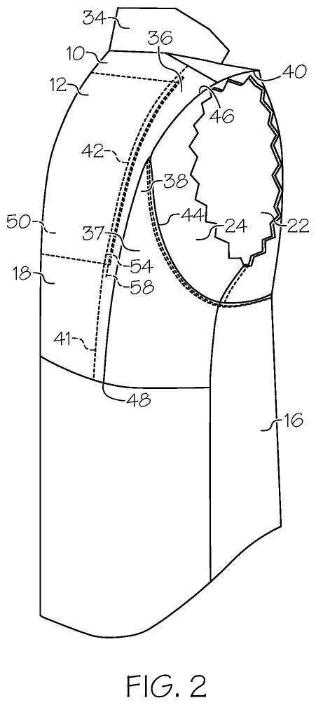

FIG. 1 illustrates a protective or hazardous duty garment in the form of a firefighter's garment or coat, generally designated 10. The coat 10 may include a body or body portion 12 having a left front panel 14, right front panel 16 and a back panel 18 (FIGS. 2-4, 6 and 7). The left front panel 14 and right front panel 16 may be releasably attachable by a fastener 20, such as a zipper, snaps, clasps, clips, hook-and-loop fastening material (e.g., VELCRO® fastening material), magnets, combinations of these components or the like. The body portion 12 may define a torso cavity 22 that is shaped and configured to receive a wearer's torso therein. The coat 10 may include a pair of sleeves 24 coupled to and extending generally outwardly from the body portion 12 and shaped to receive a wearer's arms therein, and a collar 34. In one case each sleeve 24 is configured to cover at least about 90% of a wearer's arms when the coat 10 is worn. The panels 14, 16, 18 and sleeves 24 can each be made of various subcomponents attached together, or each can each be made of a single, unitary, seamless piece of material.

The coat 10 may include various layers through its thickness to provide various heat, moisture and/or abrasion resistant qualities to the coat 10 so that the coat 10 can be used as a protective, hazardous duty and/or firefighter garment. For example, with reference to FIG. 1 the coat 10 may include an outer shell, outer layer or outer material 26, a moisture barrier 28 located inside of and adjacent to the outer shell 26 (e.g. positioned between the outer shell 26 and the torso cavity 22), a thermal liner or barrier 30 located inside of (or outside of) and adjacent to the moisture barrier 28, and an inner liner or face cloth 32 (such as chambray fabric) located inside of and adjacent to the thermal barrier 30.

The outer shell 26 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Delaware), and commercially available polybenzamidazole fibers include PBI fibers (a trademark of PBI Performance Fabrics of Charlotte, North Carolina). Thus, the outer shell 26 may be an aramid material, a blend of aramid materials, a polybenzamidazole material, a blend of polybenzamidazole fibers, a blend of aramid and polybenzamidazole materials, a poly-phenylene benzobisoxazole (PBO) material, a thermostable organic polymer material, such as KERMEL® material sold by Kermel SAS of Colmar, France, a blend of any of the materials listed above, or other appropriate materials.

If desired, the outer shell 26 may be coated with a polymer, such as a durable, water repellent finish or coating (i.e. a perfluorohydrocarbon finish, such as TEFLON® finish sold by E.I. Du Pont de Nemours and Company of Wilmington, Delaware, or a fluorine free water repellent finish). The materials of the outer shell 26 may have a weight of, for example, between about five and about ten oz/yd². Moreover, if desired the outer shell 26 may have a self-decontaminating finish or coating, or other coating, applied thereto.

The moisture barrier 28 and thermal barrier 30 may be generally coextensive with the outer shell 26, or spaced slightly inwardly from the outer edges of the outer shell 26 (i.e., spaced slightly inwardly from the outer ends of the sleeves 24, the collar 34 and/or from the lower edge or hem of the coat 10) to provide moisture and thermal protection throughout the coat 10. The moisture barrier 28 may include a semi-permeable membrane layer 28a and a substrate 28b.

The membrane layer 28a may be generally water vapor permeable but generally impermeable to liquid moisture. The membrane layer 28a may be made of or include expanded polytetrafluoroethylene (“PTFE”) such as GORE-TEX or CROSSTECH materials (both of which are trademarks of W.L. Gore & Associates, Inc. of Newark, Delaware), STEDAIR membrane material sold by Stedfast, Inc. located in Quebec Canada, polyurethane-based materials, neoprene-based materials, cross-linked polymers, polyaramid, or other materials. The membrane layer 28a may have microscopic openings that permit moisture vapor (such as water vapor) to pass therethrough, but block liquids (such as liquid water) from passing therethrough. The membrane layer 28a may be made of a microporous material that is either hydrophilic, hydrophobic, or somewhere in between. The membrane layer 28a may also be monolithic and may allow moisture vapor transmission therethrough by molecular diffusion. The membrane layer 28a may also be a combination of microporous and monolithic materials (known as a bicomponent moisture barrier), in which the microporous or monolithic materials are layered or intertwined.

The membrane layer 28a may be bonded, adhered or otherwise coupled to the substrate 28b of a flame and heat resistant material to provide structure and protection to the membrane layer 28a. Thus, either the membrane layer 28a alone, or the membrane layer 28a in combination with the moisture barrier substrate 28b, may be considered to constitute the moisture barrier 28. The substrate 28b may be or include aramid fibers similar to the aramid fibers of the outer shell 26, but may be thinner and lighter in weight. The substrate 28b may be woven, non-woven, spunlace or other materials. In the illustrated embodiment, the membrane layer 28a is located between the outer shell 26 and the substrate 28b. However, the orientation of the moisture barrier 28 may be reversed such that the substrate 28b is located between the outer shell 26 and the membrane layer 28a.

The thermal barrier 30 may be made of nearly any suitable flame resistant material that provides sufficient thermal insulation. In one embodiment, the thermal barrier 30 may include a layer of bulk material 30a in the form of relatively thick (i.e. between about 1/16″- 3/16″) batting, felt or needled non-woven bulk or batting material. The bulk material 30a can include aramid fiber batting (such as NOMEX batting), aramid needlepunch material, an aramid non-woven material, an aramid blend needlepunch material, an aramid blend batting material, an aramid blend non-woven material, foam (either open cell or closed cell), or other suitably thermally insulating materials. The bulk material 30a may trap air and possess sufficient loft to provide thermal resistance to the coat 10.

The bulk material 30a may be quilted or otherwise coupled to a thermal barrier face cloth 30b which can be a weave of a lightweight aramid material. Thus, either the bulk material 30a alone, or the bulk material 30a in combination with the thermal barrier face cloth 30b, may be considered to constitute the thermal barrier 30. In the illustrated embodiment, the thermal barrier bulk material 30a is located between the outer shell 26 and the thermal barrier face cloth 30b. However, the orientation of the thermal barrier 30 may be reversed such that the thermal barrier face cloth 30b is located between the outer shell 26 and the bulk layer 30a. If desired, the thermal barrier 30 may be treated with a water-resistant or water-repellent finish. In one embodiment, the thermal barrier 30 (and/or the coat 10 as a whole) may have a thermal protection performance (“TPP”), as specified in the 1986 revision of the National Fire Protection Association (“NFPA”) 1971, Protective Clothing for Structural Fire Fighting Standards, of at least about twenty, and the coat 10 as a whole may have a TPP of at least about thirty-five, although the TPP values can vary.

Although the moisture barrier 28 is shown as being located between the outer shell 26 and the thermal barrier 30, the positions of the moisture barrier 28 and thermal barrier 30 may be reversed such that the thermal barrier 30 is located between the outer shell 26 and the moisture barrier 28, or additional moisture barrier 28 and/or thermal barrier layers 30 can be utilized or various other orientations or configurations may be used.

The face cloth 32 may be the innermost layer of the coat 10, located inside the thermal barrier 30 and moisture barrier 28. The face cloth 32 can provide a comfortable surface for the wearer and protect the thermal barrier 30 and/or moisture barrier 28 from abrasion and wear. The face cloth 32 may be quilted to the adjacent layer (i.e. the thermal barrier 30 in the illustrated embodiment). However, the face cloth 32 is optional and may be excluded if desired. In addition, the coat 10 may not necessarily include the moisture barrier 28 and/or the thermal barrier 30 in certain cases.

Each layer of the coat 10 disclosed herein, including the layers and components described above, as well as those described below, and the coat 10 as a whole, may meet the National Fire Protection Association (“NFPA”) 1971 standards for protective firefighting garments (“Protective Clothing for Structural Firefighting”), which standards as of the filing date of this application are entirely incorporated by reference herein. The NFPA standards specify various minimum requirements for heat and flame resistance and tear strength. For example, in order to meet the NFPA standards, the outer shell 26. moisture barrier 28, thermal barrier 30 and face cloth 32 must be able to resist igniting. burning, melting, dripping, separation, and/or shrinking more than 10% in any direction after being exposed to a temperature of 500° F. for at least five minutes. Furthermore, in order to meet the NFPA standards, the combined layers of the coat 10 must provide a TPP rating of at least thirty-five.

Alternately or in addition to the NFPA Standard 1971, the coat 10 and other components disclosed herein may meet standards of other countries or regions, including the European Norm (“EN”) standards for firefighting garments set by the European Committee for Standardization (also known as Comité Européen de Normalisation (“CEN”)). These standards include EN 469:2005 Level 1 and Level 2 certification. The EN standards for firefighter and protective garments in place as of the filing date of this application are entirely incorporated by reference herein.

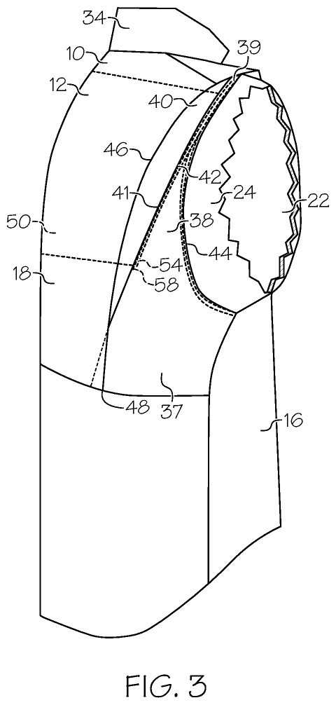

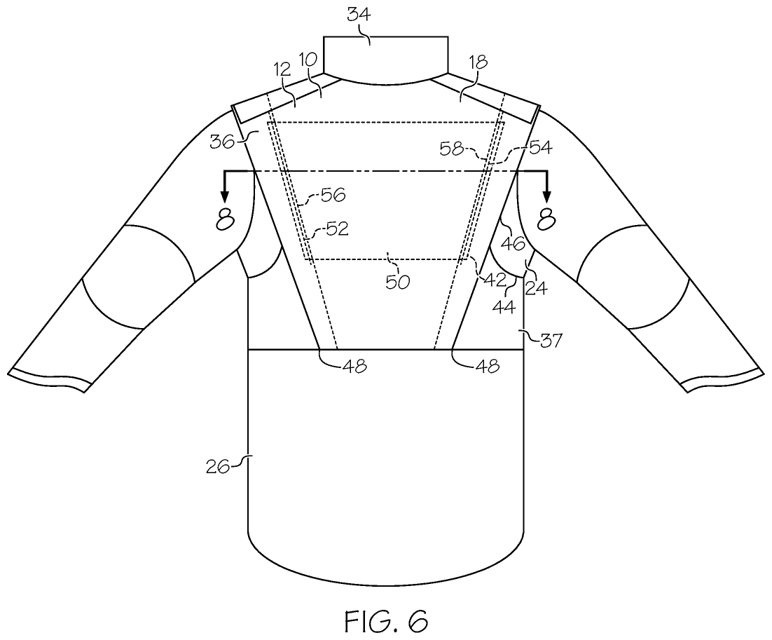

With reference to FIGS. 2-9, the coat 10 can include a pair of opposed pleats 36, where each pleat 36 is positioned at or adjacent to a shoulder of the coat 10 at location where the associated arm 24 is coupled to the body portion 12. Each pleat 36 can include an inner ply 38 (“inner” with regard to a thickness direction of the coat 10, when the pleat 36 is in the retracted position, as described below) and an outer ply 40. The inner ply 38 and outer ply 40 of the pleats 36 can be made of the same material, and in the illustrated embodiment are made of outer shell material 26. The inner edges (with respect to the lateral direction, or the left-to-right direction in FIGS. 6 and 8, when the pleat 36 is in the retracted position, as described below) of the inner 38 and outer 40 plies are directly coupled to each other at or along a fold or junction 41 (see FIGS. 3, 8 and 9). In one embodiment a coupling mechanism 42, such as stitching, adhesives or the like forming a seam in one case, is located at and/or extends through the inner (in the lateral, or left-to-right direction) edges of the inner ply 38 and the outer ply 40 to couple the inner ply 38 and the outer ply 40 together. The coupling mechanism 42 can be located at or adjacent to (or define) the fold 41. The pleat 36 (e.g. the inner ply 38 and the outer ply 40) can be made of the same, unitary seamless piece of material, and in this case the coupling mechanism 42 can bias the inner 38 and outer 40 plies in or to the folded or retracted configuration shown in FIGS. 2, 6 and 8, at least in the vicinity of the coupling mechanism 42, and thereby help bias the pleat 36 to its retracted position.

Making the pleat 36/inner ply 38 and the outer ply 40 of the same, unitary seamless piece of material helps to ensure a strong connection and eliminates seams. Additional seams can provide the potential for additional seam failure, and reducing seams can thus reduce the failure rate. In addition, making the inner ply 38 and outer ply 40 of the same, unitary seamless piece of material can be counter-intuitive in that it may be more cost effective to make the inner ply 38 and outer ply 40 of separate pieces of material to ensure all parts and components of purchased fabric material are used efficiently. Thus it can be less efficient from a material-use and efficiency standpoint to make the inner ply 38 and outer ply 40 of the same, unitary seamless piece of material, but can provide certain performance advantages.

The outer edge (with respect to the lateral direction, or the left-to-right direction in FIGS. 6 and 8, when the pleat 36 is in the retracted position, as will be described in greater detail below) of the inner ply 38 is coupled to an outer shell portion 26 of the coat 10 that forms the associated sleeves 24, as the outer most layer thereof. In the illustrated embodiment (see FIGS. 2, 3 and 7-9) the inner ply 38 of each pleat 36 and the outer shell 26 of the sleeves 24 are made of separate pieces of outer shell material joined together by a coupling mechanism 44. However if desired the inner ply 38 and sleeves 24 can be made of the same unitary seamless piece of material.

The outer edge (with respect to the lateral direction, or the left-to-right direction in FIGS. 6 and 8) of the outer ply 40 is coupled to the back panel 18 that forms or extends across the back of the coat 10, as the outermost layer thereof. A coupling mechanism 46 is located at and/or extends through the outer edges of the outer ply 40 and back panel 18 to couple the outer ply 40 and the back panel 18/body portion 12 together. In one case, the outer ply 40 (and inner ply 38 if desired) and the back panel 18 are made of the same, unitary seamless piece of material, and the coupling mechanism 46 helps to retain the outer ply 40 and the back panel 18 in the folded configuration shown in FIGS. 2, 6 and 8, at least in the vicinity of the coupling mechanism 46. Making the outer ply 40 (and inner ply 38 if desired) and the back panel 18 are made of the same, unitary seamless piece of material, provides the same or similar advantages as described above in making the inner ply 38 and outer ply 40 from the same unitary piece of material, and also may go against conventional manufacturing methods as outlined above. However if desired the outer ply 40 (and/or inner ply 38) and back panel 18 need not be made of the same unitary seamless piece of material.

With reference to FIGS. 2-4, each pleat 36 can extend generally circumferentially around an associated sleeve or arm 24 at the shoulder of the coat 10. Each pleat 36 can be configured generally as an inverted “U” in side view, with two lower ends 48 of the “U” positioned below the shoulders. Thus each pleat 36 can extend at least about 150 degrees in one case, and about 180 degrees in the illustrated embodiment, circumferentially about the associated sleeve 24 to provide enhanced flexibility and mobility as will be described in greater detail below. In another case one or each pleat 36 can be at least partially located on a back of the coat 10, or be at least partially located on a back and front of the coat 10. It has found that this arrangement of pleats 36 can provide significantly improved mobility and freedom of movement of the wearer. In particular, pleats 36 that are positioned only on the back of a coat may provide freedom of movement to a wearer when reaching their arms forwardly. However, pleats 36 positioned in the manner disclosed herein can provide freedom of movement to a wearer that reaches their arms forwardly, straight up and/or backwardly.

Each pleat 36 can be movable between a retracted position, as shown in FIGS. 2, 4, 5, 6 and 8, and an expanded position as shown in FIGS. 3, 5A, 7 and 9. With reference to FIG. 8, when the associated pleat 36 is in the retracted position, the inner ply 38 is positioned closer to the torso cavity 22 in a thickness of the coat 10, and the outer ply 40 is positioned outside of, and generally covers, the inner ply 38 in the thickness direction 43. The inner 38 and outer 40 plies can be generally aligned and generally parallel (in one case, form an average angle therebetween of within (less than) about twenty degrees, or in another embodiment of within (less than) about thirty degrees). Furthermore, when in the retracted position the inner 38 and outer 40 plies generally overlap in the thickness direction, or at least partially overlap in the thickness direction such that a line extending in the thickness direction (vertical direction of FIG. 8; see arrow 43) extends through both plies 38, 40. The outer ply 40 can be positioned further from the torso cavity 22 in the thickness direction than the inner ply 38 such that the inner ply 38 is positioned between the outer ply 40 and the torso cavity 22 in a thickness direction of the coat 10.

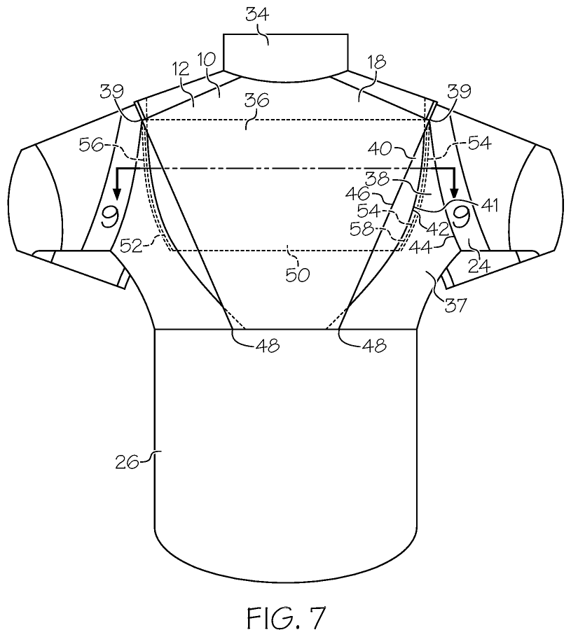

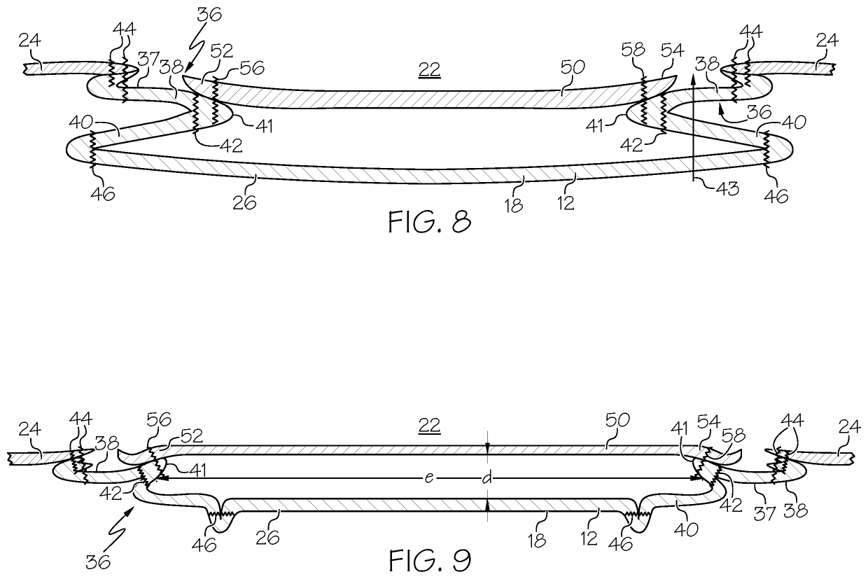

When each pleat 36 is in the expanded position such as shown for example in FIGS. 7 and 9, the inner 38 and outer 40 plies are not aligned or not generally aligned but can be generally parallel. When in the expanded position, as is the case in the retracted position, the outer ply 40 can be positioned further from the torso cavity 22 in the thickness direction than the inner ply 38 such that the inner ply 38 is positioned between the outer ply 40 and the torso cavity 22 in a thickness direction of the coat 10. The inner 38 and outer 40 plies may not generally overlap in the thickness direction (or overlap less as compared to when the pleat 36 is in the retracted position—e.g. line 43 of FIG. 8 does not extend through both plies 38, 40), and in this manner the pleats 36/inner 38 and outer 40 plies can be configured and move in the manner of accordion-style material.

When the pleats 36 are in the expanded position, the inner ply 38 and outer ply 40 may not overlap at all in the thickness direction (such that no line extending in the thickness direction (vertical direction of FIG. 9) can be drawn that extends through both plies 38, 40). Alternatively the inner ply 38 and outer ply 40 may partially overlap (such that for example a first line in the thickness direction is able to be drawn that overlaps with both plies 38, 40, and a second line drawn in the same direction, that does not overlap both plies is also able to be drawn). In addition, when in the expanded, the pleat 36, and each of the inner 38 and/or outer 40 plies thereof, may be located in a laterally outward position compared to when in the retracted position. In this manner, since the inner ply 38 can be positioned in a laterally outer position when in the expanded position, the outer ply 40 can be pulled in tighter in the thickness direction (dimension d of FIG. 9), closer to the torso cavity 22, compared to when the pleat 36 is in the retracted position.

The ability of the coat 10/pleats 36 to move to the expanded position provides enhanced mobility and comfort to the wearer. In particular, when each pleat 36 is in its expanded position, the coat 10/back panel 18 has a greater width dimension (or effective width) e (see FIG. 9) in the lateral direction, thereby providing additional space in the lateral direction in the torso cavity 22. The coat 10 is thereby configured to form a tighter fit on the wearer 10 when the pleats 36 are in the retracted positions, and to form a looser fit when the pleats 36 are in the expanded positions, and to do so automatically, without any operation or manual manipulation by the user/wearer. This additional space can help to provide greater room and maneuverability to the wearer, for example when the wearer raises their arms or moves their arms forwardly or backwardly, and helps to ensure that the coat 10 does not bind on the wearer or restrict their freedom of movement.

With reference to FIGS. 2, 3 and 6-9, the coat 10 can include at least one piece of elastic material 50 coupled to the body portion 12 and configured to bias at least one, or both, pleats 36 to the retracted position. The piece of elastic material 50 can be positioned inside (with respect to a thickness direction) the back panel 18/outer shell 26 such that the piece of elastic material 50 is configured to be positioned between the back panel 18/outer shell 26 and the torso cavity 22/wearer of the coat 10, and positioned outside of the moisture barrier 28, thermal barrier 30 and face cloth 32 (if utilized, shown in FIG. 1) in one case. As best shown in FIGS. 8 and 9, the piece of elastic material 50 can have first 52 and second 54 opposed ends, where one end 52 is coupled to one of the pleats 36 by first coupling mechanism 56 and the other end 54 is coupled to the other pleat 36 by a second coupling mechanism 58. In this configuration the piece of elastic material 50 extends continuously between the two pleats 36 and extends entirely or substantially entirely across the back panel 18 of the coat 10.

In the illustrated embodiment the piece of elastic material 50 is coupled to the inner ply 38 of each pleat 36, at a laterally inner portion, at or adjacent to the coupling mechanism 42. However the piece of elastic material 50 could instead or in addition be coupled to the outer ply 40. In one case the piece of elastic material 50 terminates at or adjacent to the coupling mechanism(s) 56/58/42, and does not extend laterally to the pleats 36, and does not fully overlap with the pleat 36, the inner ply 38 and/or the outer ply 40. In addition, the piece of elastic material 50 is, in one case, not positioned in or on the sleeve 24 of the coat 10 or any portion thereof to provide material savings and increase the ease of movement of those portions of the coat 10.

The piece of elastic material 50 is expandable/stretchable (the term “elastic” is used herein to encompass both terms). In one case the piece of elastic material 50 has elasticity such that it can be extended in length in the lateral direction (left-to-right in FIGS. 6-9), in the direction of applied stretching forces, without breaking, but is biased or desires/applies a force to return to its original, un-biased shape/length. In one case the piece of elastic material 50 is stretchable by at least about 2% in one case, or at least about 5% in another case, or at least about 10% in yet another case along its length when stretching forces are applied, and is configured to return to its original undeformed shape/position when stretching forces are no longer applied. In one case, the piece of elastic material 50 is or includes NOMEX® nano flex material, sold by DuPont Safety & Construction, Inc. of Wilmington Delaware, positioned between two layers of a fire resistant knit material.

The piece of elastic material 50 can be configured such that when one or both pleats 36 are in the expanded position the piece of elastic material 50 is in tension, and when one or both pleats 36 are in the retracted position the piece of elastic material 50 is in less tension as compared to when one or both pleats 36 are in the expanded position, or is relaxed/not in tension. In this manner the piece of elastic material 50 automatically biases the pleats 36 to their retracted positions without any manual operation or input from the wearer. The piece of elastic material 50 thereby ensures that the pleats 36 do not remain in the expanded position when it not needed (e.g. when the wearer is not raising or extending their arms), and the pleats 36 instead move away from their expanded positions, toward or into the retracted position, to ensure a better fit is provided about the wearer, to avoid undue bulkiness, and to present a better more streamlined appearance/aesthetic. The elastic material 50 can thus pull the pleats 36 into or toward the retracted positions automatically, without any user operation or manual manipulation.

In this manner the piece of elastic material 50 is directly coupled to each pleat 36 at opposite ends thereof and is configured to bias both pleats 36 to their retracted positions. The piece of elastic material 50 has a height that can extend at least about 20% of a height of both pleats 36 in one case along the back of the coat 10 and/or at least about 50% of a height of the coat 10 to ensure the pleats 36 are properly biased to their retracted positions.

FIGS. 6-9 illustrate an embodiment in which a single piece of elastic material 50 biases each pleat 36 to its retracted position. However if desired the coat 10 can include two (or more) separate pieces of elastic material, where each, or at least one, piece of elastic material 50 is coupled to an associated pleat 36 at one end, and to the coat 10, such as the body portion 12/outer shell 26 and/or layers 28/30/32, at the other end to individually bias each pleat 36.

With reference to FIG. 3, in that illustrated embodiment and also in the embodiment of FIGS. 6-9, the inner ply 38 of each pleat 36 on the back of the coat 10 can constitute or be defined/contributed by an inner portion of segment 37 (that can be formed as a unitary/seamless portions with the back panel 18) positioned generally below the sleeve 24. However, as can be best seen in FIGS. 3 and 7, the segment 37 has a reduced width (in the left-to-right direction) moving in the upper direction, and eventually tapers to a point 39 (at or adjacent to a top of the shoulder of the coat 10) such that the segment 37 is not carried over to the front of the coat 10.

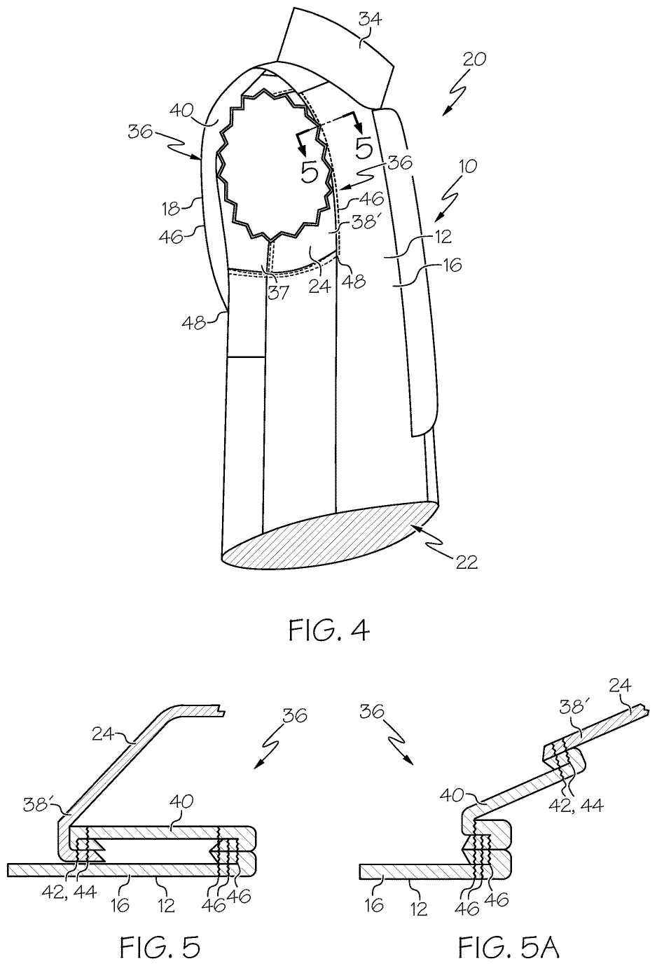

In this case, as shown in FIGS. 4, 5 and 5A, the portion of the pleats 36 on the front portions of the coat 10 can have an inner ply 38′ that is not made of the segment 37, and instead is defined or contributed by an axially inner portion of the sleeve 24. In addition, in the illustrated embodiment the inner ply 38′ is not formed of a single, unitary piece of material with the outer ply 40. Instead, in this embodiment the inner ply 38′/sleeve 24 is joined to the outer ply 40 by the stitching/coupling mechanism 42. In this case, the seams 42, 44 (which are spaced apart from the portion of the pleats 46 on the back of the coat 10) converge or overlap on the portion of the pleats 36 on the front of the coat 10. In addition, in this embodiment the portion of the pleats 36/outer ply 40 on the front of the coat 10 may not be made of a unitary/seamless part with the front panel 16/body portion 12 (unlike the portion of the pleats 36 on the back of the coat 10, in the illustrated embodiment). In this case the outer ply 40 can be coupled to the front panel 16 by the coupling mechanism 46.

Thus, while the pleats 36 can extend continuously from the back of the coat 10 to the front of the coat 10, the pleats 36 can be made of a single, unitary piece of material on the back of the coat 10 and from two/three separate pieces of material joined together at seams 42/46 on the front of the coat 10. The portion of the pleats 36 on the back of the coat 10 may provide more expansion capability than the portions of the pleats 36 on the front of the coat 10 due to the additional width provided by the segment 37. However the coat 10 typically has a lesser need for expansion on the front of the coat 10 and thus the portion of the pleats 36 on the front of the coat 10 can provide sufficient expansion capability. It should also be noted that, in the illustrated embodiment, the piece of elastic material 50 is not present on or across the front of the coat 10, and thus is not visible in FIGS. 5 and 5A. Nevertheless the portion of the pleats 36 on the front of the coat 10 can still be biased to their retracted positions by the piece of elastic material 50 and/or the natural shape of the pleats 36, due to for example the stitching/coupling mechanisms 42, 46.

In addition, FIGS. 6-9 and the description above show the pleats 36 being formed in the outer shell 26 as the garment portion. However, alternatively or in addition, the pleats 36 can be formed in the moisture barrier 28, thermal barrier 30, face cloth 32 and/or other layers of the coat 10 as the garment portion. In this case a piece of elastic material 50 can be omitted, or if used, can be coupled to each pleat 36 in the associated layer 28, 30 or 32, and the pleats 36/elastic material 50 can be configured and operate as shown in the figures and description above. In addition, while the coat 10 is shown as including two pleats 36, in one case if desired only a single pleat 36 may be utilized.

With reference to FIGS. 10-13, when the pleats 36 are formed in the moisture barrier 28 and/or thermal barrier 30 and/or face cloth 32, the pleats 36 can in one case have generally the same configuration as that shown above for the pleats 36 in the outer shell 26, and be provided either with or without the piece of elastic material 50. In some cases, when the pleats 36 are formed in the moisture barrier 28, the pleats 36 may lack the coupling mechanisms 42, 46, to reduce the number of locations where the moisture barrier 28 is breached/penetrated to improve the structural integrity and operating characteristics of the moisture barrier 28 and thereby limit the penetration of moisture through the moisture barrier 28. In addition, if desired a piece of elastic material 50 may not be used with the pleats 36 of the moisture barrier 28 to further limit the penetration of moisture through the moisture barrier 30 due to the coupling mechanisms 56, 58 that couple the piece of elastic material 50.

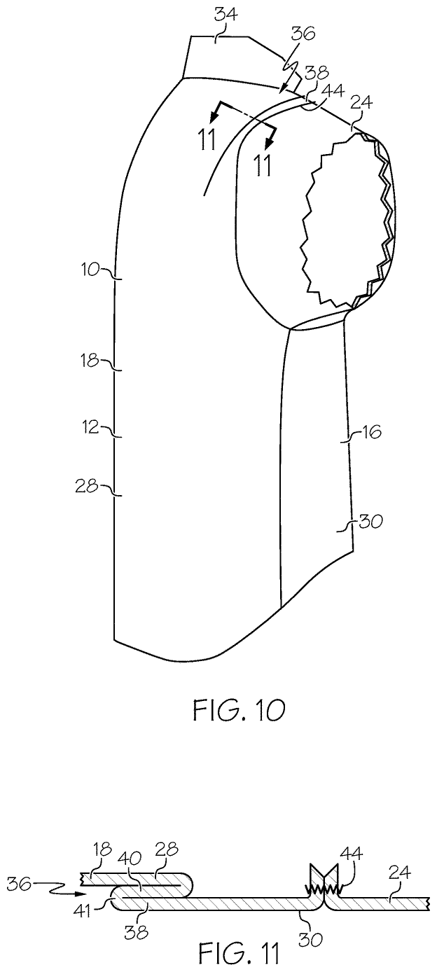

However, the pleats 36 of the moisture barrier 30 can still be biased to their retracted positions as shown in FIGS. 10 and 11. In particular, the pleats 36 of the adjacent layers of the thermal barrier 30 and/or outer shell 26 or other layers may include the coupling mechanism 42, 46 and/or associated pieces of elastic material 50 and thereby be biased to their retracted positions. Thus frictional engagement between the layers 26/28/30/32 can thereby pull the pleats 36 of the moisture barrier 28 to the retracted position.

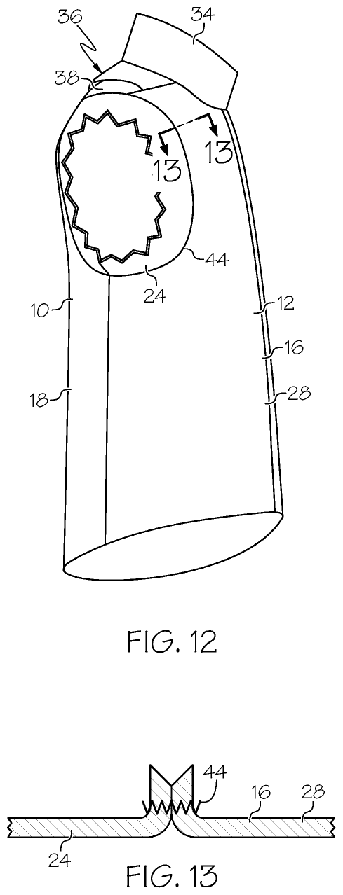

As shown in FIG. 12, the pleats 36 of the moisture barrier 28 may not carry over/across the front of the coat 10 to the same extent as the pleats 36 of other layers, such as the outer shell 26 embodiment of FIG. 4. However, the moisture barrier 30 may have some fullness/excess material 50 at or adjacent to the sleeve 24 that naturally folds up to provide blousing and thereby and provides some expansion capacity when the sleeves 24 are reached forwardly by the wearer.

Having described the invention in detail and by reference to certain embodiments, it will be apparent that modifications and variations thereof are possible without departing from the scope of the invention.

1. A coat comprising:
a garment portion including a body portion configured to cover a torso of a wearer, a pair of sleeves coupled to the body portion and configured to cover a wearer's arms, and a pleat positioned adjacent to one of the sleeves, wherein the pleat is movable between an expanded position and a retracted position; and
at least one piece of elastic material coupled to the garment portion and configured to bias the pleat to the retracted position.

2. The coat of claim 1 further comprising a supplemental pleat coupled to the other one of the sleeves, wherein the supplemental pleat is movable between an expanded position and a retracted position.

3. The coat of claim 2 wherein the at least one piece of elastic material is directly coupled to each pleat at opposite ends thereof and is configured to bias both pleats to their retracted positions.

4. (canceled)

5. The coat of claim 2 wherein the body portion includes an outer shell having a back panel extending continuously between the pleat and the supplemental pleat, wherein the back panel, portions of the pleat on a back of the coat and portions of the supplemental pleat on the back of the coat are made of a single, unitary seamless piece of material.

6. The coat of claim 1 wherein the coat has a greater effective width across a back thereof when the pleat is in the expanded position compared to when the coat is in the retracted position.

7. The coat of claim 1 wherein the pleat includes an inner ply and an outer ply, wherein the pleat is configured such that when the pleat is in the retracted position the inner ply and outer ply are generally overlapping in a thickness direction, and when the pleat is in the expanded position the inner ply and outer ply are not generally overlapping, or are less overlapping as compared to when the pleat is in the retracted position.

8. The coat of claim 7 wherein the inner ply and outer ply are configured to be oriented generally parallel in both the retracted position and the expanded position wherein the inner ply and the outer ply are directly coupled to each other along a seam, and wherein the inner ply and the outer ply are made of a single, unitary seamless piece of material.

9. (canceled)

10. (canceled)

11. (canceled)

12. (canceled)

13. (canceled)

14. The coat of claim 7 wherein the pleat includes a fold positioned between the inner and outer ply, and wherein the coat includes a coupling mechanism located at or adjacent to the fold to bias the pleat to its retracted position.

15. (canceled)

16. (canceled)

17. (canceled)

18. The coat of claim 1 wherein the body portion includes an outer shell having a front panel, wherein the front panel and a portion of the pleat on the front of the coat are made of separate pieces of material that are coupled together.

19. (canceled)

20. The coat of claim 1 wherein the pleat extends generally circumferentially around the one of the sleeves at a shoulder of the coat and wherein the pleat is configured generally as an inverted “U” in side view.

21. (canceled)

22. The coat of claim 1 wherein the pleat extends generally circumferentially such that at least part of the pleat is positioned on a back of the coat and at least part of the pleat is positioned on a front of the coat.

23. (canceled)

24. The coat of claim 1 wherein the pleat includes an inner ply and an outer ply, and wherein the at least one piece of elastic material is coupled to the inner ply of the pleat.

25. (canceled)

26. The coat of claim 1 wherein the pleat includes an inner ply and an outer ply, and wherein the inner ply is directly coupled to the one of the sleeves, wherein the outer ply is directly coupled to at least one of a back panel or a front panel of the coat, and wherein the piece of elastic material has a height of at least about 20% of a height of the coat.

27. The coat of claim 1 wherein the at least one piece of elastic material does not fully overlap with the pleat, wherein the at least one piece of elastic material is not positioned in or on the one of the sleeves.

28. (canceled)

29. (canceled)

30. The coat of claim 1 wherein the elastic material is stretchable by at least about 5% in an associated particular stretch direction when stretching forces are applied, and is configured to return to an original position when stretching forces are no longer applied, wherein the coat further includes a moisture barrier positioned inside said garment portion such that said moisture barrier is configured to be positioned between said garment portion and a wearer when said garment is worn, and wherein the garment portion is: a) an outer shell made of an abrasion resistant material that resists igniting, burning, melting, dripping, or separation when exposed to a temperature of 500° F. for five minutes; or b) a thermal barrier having a TTP of at least about thirty five, and wherein the thermal barrier is positioned inside an outer shell of the coat such that thermal barrier is configured to be positioned between the outer shell and wearer of the coat.

31. (canceled)

32. (canceled)

33. (canceled)

34. A coat comprising:
a garment portion including a body portion configured to cover a torso of a wearer, a pair of sleeves coupled to the body portion and configured to cover a wearer's arms, and at least one pleat positioned adjacent to one of the sleeves, wherein the pleat is movable between an expanded position and a retracted position, wherein the pleat extends generally circumferentially at least about 150 degrees around the one of the sleeves at a shoulder of the coat, wherein the pleat extends continuously from a back of the coat to a front of the coat, and wherein at least part of the pleat is located at a top of the shoulder of the coat.

35. The coat of claim 34 wherein the pleat is configured generally as an inverted “U” in side view, wherein the pleat includes an inner ply and an outer ply, wherein the pleat is configured such that when the pleat is in the retracted position the inner ply and outer ply are generally overlapping in a thickness direction of the coat, and when the pleat is in the expanded position the inner ply and outer ply are not generally overlapping in the thickness direction, or are less overlapping as compared to when the pleat is in the retracted position.

36. (canceled)

37. The coat of claim 34 further comprising at least one piece of elastic material coupled to the garment portion and configured to bias the pleat to the retracted position, and wherein the coat further includes a supplemental pleat coupled to the other one of the sleeves, wherein the supplemental pleat is movable between an expanded position and a retracted position, and wherein the supplemental pleat extends generally circumferentially at least about 150 degrees around the one of the other one of the sleeves at a shoulder of the coat.

38. (canceled)

39. A coat comprising:
a garment portion including a body portion configured to cover a torso of a wearer, a pair of sleeves coupled to the body portion and configured to cover a wearer's arms, and a pleat positioned adjacent to one of the sleeves, wherein the pleat is movable between an expanded position and a retracted position, wherein at least part of the pleat is located on a back of the coat and at least part of the pleat is located on a front of the coat, and wherein the pleat is configured generally as an inverted “U” in side view.

40. The coat of claim 39 wherein the pleat extends generally circumferentially at least about 150 degrees around the one of the sleeves at a shoulder of the coat, and wherein the pleat has a pair of lower ends, each of which is positioned below a shoulder of the garment portion.

41. (canceled)
